(19) United States
(12) Patent Application Publication
(10) Pub. No.: US 2006/0053687 A1
(43) Pub. Date: Mar. 16, 2006

(54) Flower display and sign kit

(76) Inventor: Mark Bortman, Yardley, PA (US)

Correspondence Address: Diane Dunn McKay, Esq.;Mathews, Collins, Shepherd & McKay, P.A., 100 Thanet Circle, Suite 306, Princeton, NJ, 08540, US

(21) Appl. No.: 10/941,615

(22) Filed: Sep. 15, 2004

(51) Int. Cl. A01G 5/00; A47G 7/00

(52) U.S. Cl. 47/41.1

(57) ABSTRACT

The present invention relates to a flower display and sign kit comprising a container for receiving a flower bouquet and a sign during transportation of the flower bouquet to a desired location. A flower bouquet support is formed in the container for supporting the flower bouquet after removal of the flower bouquet from the container. The sign is assembled and coupled to the assembled flower display and sign kit is displayed in its assembled condition at the desired location.

### BACKGROUND OF THE INVENTION

1. Field of the Invention

The present invention relates to a flower display kit in which a display box is adapted to receive and support a flower bouquet and an associated sign is adapted to be expeditiously coupled to the display box.

2. Description of Related Art

Display and storage devices for flowers are known. U.S. Pat. No. 5,347,752 discloses a flower care, storage and display device provided with a grid panel having legs extending downward therefrom and supporting the grid panel above a display bucket. The display bucket allows the bottom end of the stem to rest within a body of water in order to hydrate the flower. The legs can be adjustable to a variety of displays and storage bucket diameters.

U.S. Pat. No. 5,456,046 describes a bouquet display apparatus. A flower holder portion is adapted for holding a circular arrangement of flowers. A bracket is associated with the flower holder for attaching the flower holder to a table.

U.S. Pat. No. 5,421,011 describes a point of purchase display including a display sign supported by a side of a box. A holder base section and two connecting sections include a plurality of foldable sections of a middle section and two connecting sections. A backboard of the sign is received between the foldable sections.

It is desirable to provide a flower display kit for delivery to stores having an easily assembled support for a flower bouquet and an associated sign.

### SUMMARY OF THE INVENTION

The present invention relates to a flower display and sign kit comprising a container for receiving a flower bouquet and a sign during transportation of the flower bouquet to a desired location. A flower bouquet support is formed in the container for supporting the flower bouquet after removal of the flower bouquet from the container. For example, the flower bouquet support can be formed of a plurality of support flaps extending from upper flaps of the container. The sign is assembled and coupled to the container. For example, the sign can include a sign support which is received within an opening formed of perforated sections of the container. In one embodiment, the sign comprises a sign face including indicia of reasons for purchasing flowers. Thereafter, the assembled flower display and sign kit is displayed in its assembled condition at the desired location.

The invention will be more fully described by reference to the following drawings.

### BRIEF DESCRIPTION OF THE DRAWINGS

FIG. 1 is a perspective view of an assembled flower display and sign kit in accordance with the teachings of the present invention.

FIG. 2A is a perspective view of a container in a closed position for use in the flower display and sign kit.

FIG. 2B is a perspective view of the container in an open position.

FIG. 2C is a perspective view of the container in an open position upon removal of the flower bouquet.

FIG. 2D is a perspective view of a flower bouquet support positioned on top of the container.

FIG. 2E is a perspective view of a receipt of the flower bouquet in the flower bouquet support.

FIG. 3A is a schematic diagram of a sign for use in the flower display and sign kit.

FIG. 3B is a top plan view of a sign attachment connector to be used with the sign.

FIG. 4 is a top plan view of the container including a sign attachment section for receiving the sign.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

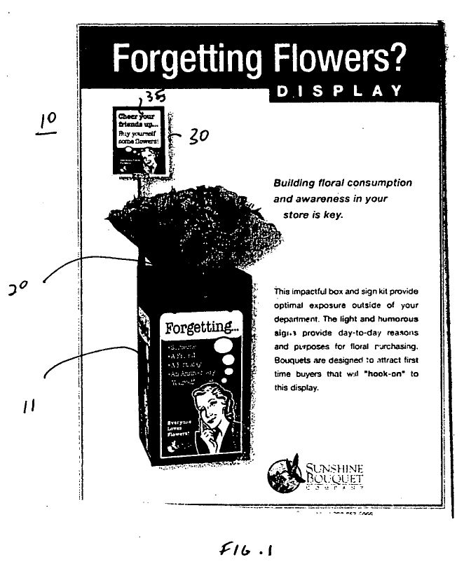

FIG. 1 is a perspective view of flower display and sign kit 10 in an assembled configuration in accordance with the teachings of the present invention. Flower display and sign kit 10 comprises container 11, flower bouquet support 20 and sign 30.

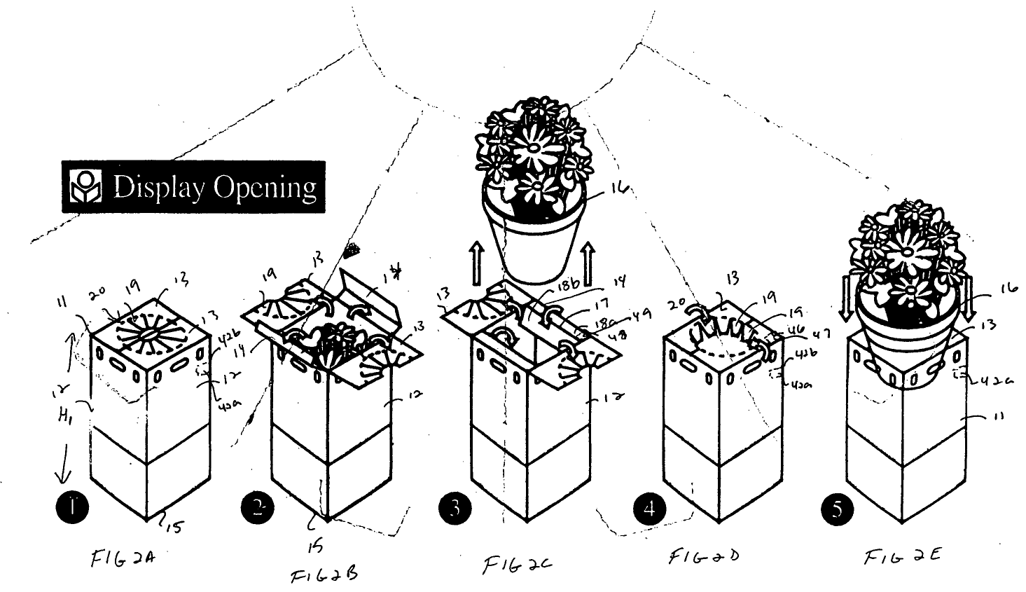

Referring to FIGS. 2A-2E, container 11 comprises sides 12, upper flaps 13, inner flaps 14 and bottom 15. Sides 12 have a height HI which is sufficient to contain a received flower bouquet 16 within container 11, as shown in FIGS. 2A and 2B. Upper flaps 13 and inner flaps 14 are attached or integral with sides 12. Upper flaps 13 and inner flaps 14 fold over flower bouquet 16 for providing protection of flower bouquet 16 when container 11 is in a closed position. For example, flower bouquet 16 can be contained within a closed container 11 during shipping of flower display and sign kit 10 to a store. Flower bouquet 16 can be supported by bottom 15 of container 11 when container 11 is in the closed position. Container 11 can be formed, for example, from cardboard or corrugated cardboard.

Flower bouquet support 20 is formed using upper flaps 13. Upper flaps 13 include a plurality of perforated support flaps 19 radially extending along upper flaps 13, as shown in FIG. 2A. Each of the perforated support flaps 19 are disengaged from adjacent support flaps to form flower bouquet support 20, as shown in FIG. 2D. Flower bouquet 16 is received in flower bouquet support 20, as shown in FIG. 2E. Container 11 can be disposable.

Upper flaps 13 and inner flaps 14 can be opened to remove flower bouquet 16 from container 11, as shown in FIGS. 2B and 2C. After removing flower bouquet 16, inner flaps 14 are folded within container 11, as shown in FIGS. 2C and 2D. Inner flaps 14 can include perforation 17 for folding inner flaps 14 into sections 18a and 18b. Upper flaps 13 are folded over and supported by section 18a of inner flaps 14.

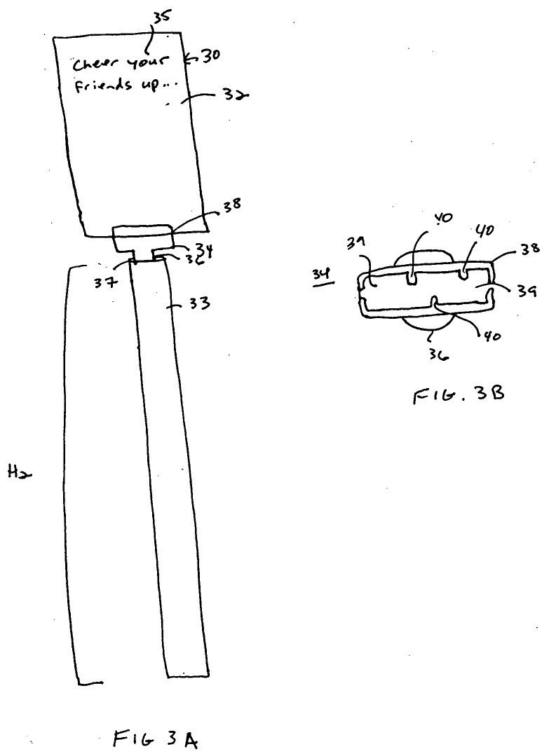

Sign 30 is coupled to container 11, as shown in FIG. 1. Sign 30 comprises sign face 32, sign support 33 and sign attachment connector 34, as shown in FIG. 3A. Sign face 32 of sign 30 can include indicia 35. For example, indicia 35 can be advertisements of reasons for purchasing flowers.

Sign support 33 can have a height H₂ which is less than or equal to height H₁ of container 11 for allowing sign 30 to be contained within container 11. For example, sign support 33 can be a hollow tube. Sign support 33 can be formed of, for example, cardboard, plastic, or wood. Sign support 33 can be disposable.

End 36 of sign attachment connector 34 has a similar shape as end 37 of sign support 33 for connecting sign attachment connector 34 to sign support 33. For example, sign attachment connector 34 can have a round shape for connecting to sign support 33 formed as a tube.

End 38 of sign attachment connector 34 comprises base 39 and protrusions 40. Protrusions 40 are spaced in rows adjacent to each other, as shown in FIG. 3B. Sign face 32 can be received between protrusions 40 thereby supporting sign face 32 in sign attachment connector 34.

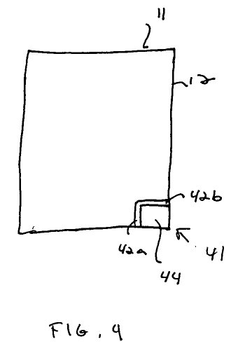

Sign attachment section 41 is formed in container 11 for supporting sign 30, as shown in FIG. 2A and FIG. 4. For example, sign attachment section 41 can comprise perforated sections 42a and 42b extending on adjacent sides 12 of container 11. Perforated sections 42a and 42b are punched out from respective sides 12 to form opening 44 within container 11. Perforated sections 42a and 42b can be integral to one another. Perforated section 46 can be formed in upper flap 13 for forming opening 47 in upper flap 13. Perforated section 48 can be formed in inner flaps 14 for forming opening 49 in inner flaps 14. Sign support 33 is received in opening 44, opening 47 and opening 49 and is held in place within container 11 by perforated sections 42a and 42b.

During operation, flower display and sign kit 10 can be assembled by assembling container 11 and placing flower bouquet 16 and a disassembled sign 30 within container 11. Container 11 can be closed by closing upper flaps 13 and inner flaps 14. Container 11 can be transported to a desired display area, such as a grocery store. At the desired location, container 11 is opened to remove flower bouquet 16 and sign 30. Flower bouquet support 20 is formed as described above. Flower bouquet 16 is received in flower bouquet support 20. Sign 30 is assembled by attaching sign face 32 to sign support 33 with sign attachment connector 34. Sign 30 is received in sign attachment section 41 of container 11. Thereafter, flower display and sign kit 10 is displayed in its assembled condition at the desired location.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A flower display and sign kit comprising:
a container for receiving a flower bouquet;
flower bouquet support means for supporting said flower bouquet on said container after removal of said flower bouquet from said container; and
a sign coupled to said container.

2. The flower display and sign kit of claim 1 wherein said container has a height which is greater than a height of said flower bouquet.

3. The flower display and sign kit of claim 1 wherein said container comprises sides and said flower bouquet support means, comprises inner flaps and upper flaps attached to said sides of said container, said inner flaps being folded into said container for supporting said upper flaps, a plurality of perforated support flaps formed in said upper flaps, and said support flaps are disengaged from adjacent ones of said support flaps to form a flower bouquet support.

3. The flower display and sign kit of claim 1 wherein said sign comprises a sign face, said sign face including indicia.

4. The flower display and sign kit of claim 3 wherein said indicia comprises an advertisement of reasons for purchasing flowers.

5. The flower display and sign kit of claim 4 wherein said sign comprises a sign attachment connector for supporting said sign face and a sign support for supporting said sign attachment connector.

6. The flower display and sign kit of claim 5 wherein a first end of said sign attachment connector has a shape similar to a first end of said sign support for attachment of said first end of said sign attachment connector to said first end of said sign support.

7. The flower display and sign kit of claim 6 wherein a second end of said sign support comprises a base and a plurality of protrusions arranged in rows extending from said base, wherein said sign face can be received between said protrusions.

8. The flower display and sign kit of claim 5 wherein said sign support is a hollow tube and said first end of said attachment connector has a round shape.

9. The flower display and sign kit of claim 5 wherein said sign support has a height which is less than or equal to a height of said container.

10. The flower display and sign kit of claim 1 wherein said sign and said container are disposable.

11. The flower display and sign kit of claim 5 further comprising a sign attachment section formed in said container for supporting said sign support.

12. The flower display and sign kit of claim 11 wherein said container attachment section comprises a first perforated section extending on a first side of said container and a second perforated section extending on a second side of said container, said first perforated section being integral to said second perforated section for forming an opening between said first perforated section and said second perforated section when said first perforated section and said second perforated section are punched out from said container.

13. A method of displaying a flower bouquet and a sign comprising the steps of:
providing a container for receiving a flower bouquet and having flower bouquet support means for supporting said flower bouquet on said container after removal of said flower bouquet from said container;
providing a sign within said container;
removing said sign from said container, and
sliding said sign into an opening in said container formed between a first perforated section extending on a first side of said container and a second perforated section extending on a second side of said container, said first perforated section being integral with said second perforated section.

14. The method of claim 14 further comprising the step of:
providing indicia on said sign of an advertisement of a reason for purchasing flowers.
